(19) United States
(12) Patent Application Publication
(10) Pub. No.: US 2007/0083683 A1
(43) Pub. Date: Apr. 12, 2007

(54) USB portable storage device with multi-port plugs

(76) Inventors: Peng-Fei Lin, Hsinchu City (TW); Ming-Hung Wang, Hsinchu City (TW)

Correspondence Address: LIN & ASSOCIATES INTELLECTUAL PROPERTY, P.O. BOX 2339, SARATOGA, CA, 95070-0339, US

(21) Appl. No.: 11/244,736

(22) Filed: Oct. 6, 2005

(51) Int. Cl. G06F 13/38

(52) U.S. Cl. 710/62

(57) ABSTRACT

A USB portable storage device with multi-port plugs is provided, including a flash memory, a USB controller, a USB physical layer, and a plurality of USB connector. The USB controller is connected to the flash memory for controlling the access to the flash memory. The USB physical layer provides the interface between the USB controller and the USB connectors, and is connected to a plurality of USB connectors to form data communication channels with all these USB connectors.

### FIELD OF THE INVENTION

The present invention generally relates to a USB storage device, and more specifically to a portable storage device with multi-port USB plugs.

### BACKGROUND OF THE INVENTION

The universal serial bus (USB) port provides the PC the capacity to connect many USB peripherals, such as USB keyboard, USB mouse, USB card reader, USB flash memory pen, plug-in USB hard disk, USB printer, and USB scanner. Due to the widespread acceptance, USB is becoming the de facto industry standard for connecting peripherals to the PC. Among them, USB flash memory pen is one of the most popular portable storage devices. On the other hand, the flash memory is also widely used in many other digital appliances, such as digital camera, TV game box, flash memory stick, and so on. As the progress of semiconductor manufacturing, the capacity of the flash memory has greatly increased. The advances in both USB and flash memory technologies have made the USB portable storage based on flash memory one of the most common peripheral for data recording and transmission. The early USB1.1 protocol supports the data transmission speed of 12 Mbps, and the present USB2.0 protocol supports the data transmission speed as high as 480 Mbps. Also, the USB On-The-Go (OTG) standard supplements the need for the connections between devices, such as between a digital camera and a USB flash memory pen.

FIG. 1 shows a block diagram of a conventional USB flash memory device 100, including a flash memory 110, a USB controller 120, a USB physical layer 130, and a USB connector 140. USB connector 140 provides the connection to USB ports on other devices, such as PC, PDA, digital camera, and so on. USB physical layer 130 is connected between USB connector 140 and USB controller 120 to provide interface functions between the two. USB controller 120 is connected between USB physical layer 130 and flash memory 110, and is responsible for access control to flash memory 110. Conceptually, USB controller 120, USB physical layer 130 and USB connector 140 can be viewed as a data communication channel between flash memory 110 and the external devices with USB ports.

The drawback of a conventional USB portable storage device is that it has only one type of USB connector. This leads to inconvenience when the USB portable storage must be used with digital devices that use other types of USB connectors.

A conventional technique to solve the above-mentioned drawback is to use a cable with different USB connectors for USB connector conversion. However, this is inconvenient as there are many types of USB connectors and a suitable one is not always readily available.

### SUMMARY OF THE INVENTION

The present invention has been made to overcome the above-mentioned drawback of conventional USB portable storage device. The primary object of the present invention is to provide a USB portable storage device with multi-port plugs.

Another object of the present invention is to provide a USB portable storage device with multi-port plugs so that the USB portable storage device can be used with devices having different types of USB connectors.

To achieve the above-mentioned objects, the present invention provides a USB portable storage device, including a flash memory, a USB controller, a USB physical layer, and a plurality of USB connector. The USB controller is connected to the flash memory for controlling the access to the flash memory. The USB physical layer provides the interface between the USB controller and the USB connectors, and is connected to a plurality of USB connectors to form data communication channels with all these USB connectors.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a block diagram of a conventional USB portable storage device; and

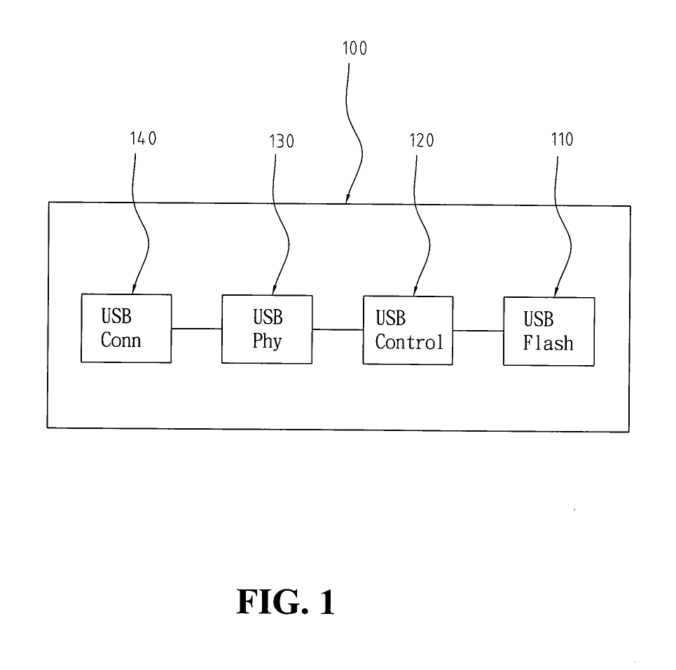

FIG. 2 shows a block diagram of a USB portable storage device with multi-port plugs according to the present invention.

### DETAILED DESCRIPTION OF THE PREFERRED EMBODIMENTS

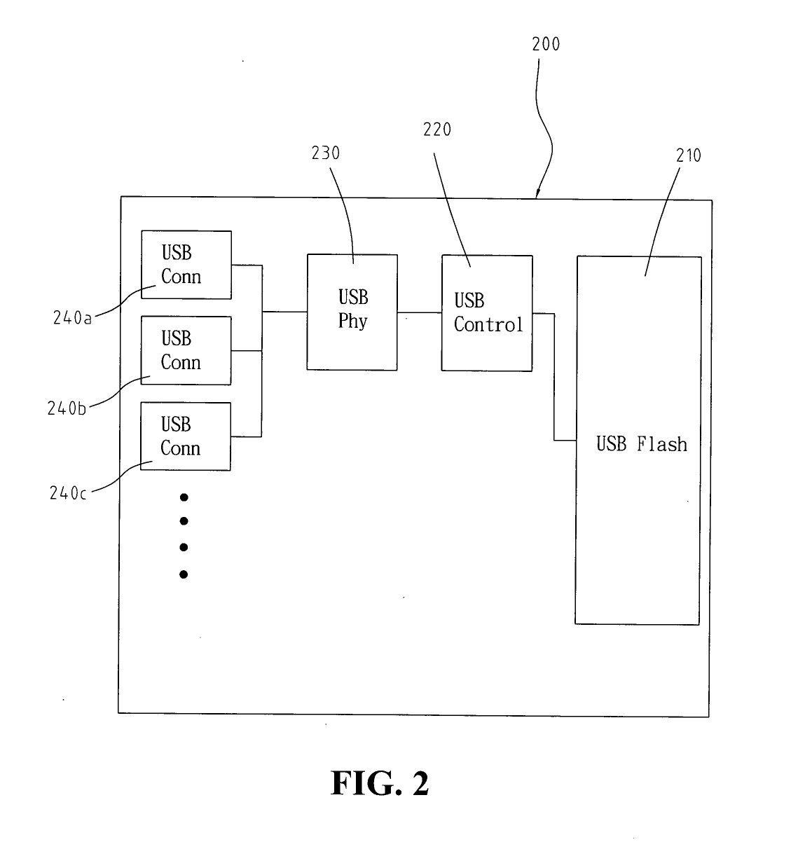

FIG. 2 shows a schematic view of a functional block diagram of a USB portable storage device with multi-port plugs according to the present invention. As shown in FIG. 2, a USB portable storage device 200 includes a flash memory 210, a USB controller 220, a USB physical layer 230, and a plurality of USB connectors 240a, 240b, 240c. USB controller 220 is connected to flash memory 210 for controlling access to flash memory 210. USB physical layer 230 is connected between USB controller 220 and USB connectors 240a, 240b, 240c to provide interface between USB controller 220 and USB connectors 240a, 240b, 240c. USB controller 220, USB physical layer 230 and each of USB connectors 240a, 240b, 240c form a data communication channel between a USB connector 240a, 240b, 240c and flash memory 210.

USB connectors 240a, 240b, 240c can be any types of USB connectors, such as USB A male, USB A female, USB B male, USB B female, USB mini A, USB mini B, and so on. USB connectors 240a, 240b, 240c can even be specific USB connector. With different types of USB connectors, USB portable device 200 of the present invention can be connected to different devices with different types of USB port.

For example, if a PC has a USB A receptacle, the present invention can use a USB A plug for connection to the PC. On the other hand, if a digital camera has a USB mini-AB receptacle, the present invention can use a USB mini-A(B) plug for connection to the digital camera.

In comparison with the conventional USB portable storage device with only one type of USB connectors, the present invention of a USB portable storage device with multi-port plugs provides better flexibility and convenience in use with other devices with different types of USB connectors.

Although the present invention has been described with reference to the preferred embodiments, it will be understood that the invention is not limited to the details described thereof Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A USB portable storage device with multi-port plugs, comprising:
a flash memory;
a flash memory controller, connected to said flash memory for controlling access to said flash memory;
a USB physical layer, connected to said flash memory controller; and
a plurality of USB connectors, each being a different type of USB connector, all connected to said USB physical layer.
